(19) United States
(12) Patent Application Publication
(10) Pub. No.: US 2015/0108055 A1
(43) Pub. Date: Apr. 23, 2015

(54) SLUDGE-DEWATERING SET, AND SLUDGE-DEWATERING DEVICE HAVING A PLURALITY OF LAYERS

(71) Applicant: Seok-Woong Kang, Anyang-si (KR)

(72) Inventor: Seok-Woong Kang, Anyang-si (KR)

(21) Appl. No.: 14/403,518

(22) PCT Filed: Aug. 22, 2012
(86) PCT No.: PCT/KR2012/006664

§ 371 Date: Nov. 24, 2014

(30) Foreign Application Priority Data
May 24, 2012 (KR) 10-2012-0055278

(51) Int. Cl. C02F 11/12

(52) U.S. Cl. CPC C02F 11/123; C02F 2303/06
USPC 210/203; 210/198.1

(57) ABSTRACT

Disclosed is a sludge dehydration set, in which a sludge filtration belt is positioned at a lower portion of a sludge chamber having an open lower portion, sludge is introduced into the sludge chamber, a pressure applying tube or a membrane is installed above the introduced sludge, water is filtered and discharged through the filtration belt by applying pressure to the sludge so that a dehydration process is performed, a structure is installed under the filtration belt and provided in the form of a steel mesh net or a matrix having many holes to support the filtration belt so that the filtration belt is not bent or sagged while moving down the dehydrated water, and the pressure is applied to the sludge by injecting liquid or air to a membrane positioned above the sludge after the sludge has been introduced into the sludge introduction part, so that the water contained in the sludge is dehydrated and moved down from the filtration belt, and a sludge dehydration apparatus manufactured by assembling a plurality of sludge hydration sets to each other at multiple layers.

### TECHNICAL FIELD

The present invention relates to a sludge dehydration set, in which a sludge filtration belt is positioned at a lower portion of a sludge chamber having an open lower portion, sludge is introduced into the sludge chamber, a pressure applying tube is installed above the introduced sludge, water is filtered and discharged through the filtration belt by applying pressure to the sludge so that a dehydration process is performed, a structure is installed under the filtration belt and provided in the form of a steel mesh net or a matrix having many holes to support the filtration belt so that the filtration belt is not bent or sagged while moving down the dehydrated water, and the pressure is applied to the sludge by injecting liquid or air to a membrane positioned above the sludge after the sludge has been introduced into the sludge introduction part, so that the water contained in the sludge is dehydrated and moved down from the filtration belt, and a sludge dehydration apparatus manufactured by assembling a plurality of sludge hydration sets to each other at multiple layers.

### BACKGROUND ART

Sludge dehydrating methods according to the related art include a belt press method and a filter press method.

According to the belt press method, after liquid containing slurry is provided between two filter belts, the filter belts are moved along a plurality of rollers. In this case, only slurry remains on the filter belts through the tension applied to the filter belts, and the liquid is discharged out of the filter belts. When excessive tension is applied to the filter belts in order to improve liquid removal efficiency, the filter bents may be broken or the slurry may be discharged to the outside through the space between the two filter belts.

According to the filter press method, after liquid containing slurry is provided among a plurality of filters, only slurry remains among the filters as pressure is applied to both end portions of the filter, and the liquid is discharged out of the filter. However, since large and heavy equipment is employed, the installation space of the equipment must be enlarged. In addition, great power consumption is required. Since the work must be performed in a wide space, bad smell may be scattered.

Korean Unexamined Patent Publication No. 10-2001-0025528 of the inventor of the present invention discloses the technical structure of removing moisture from slurry by injecting high-pressure gas into a chamber having slurry. However, problems occur when high-pressure gas passes through a filter, so that low moisture removal efficiency is represented and a slurry amount to be treated is low.

### DISCLOSURE

### Technical Problem

An object of the present invention is to efficiently treat a great amount of sludge by constructing sludge dehydration sets, each of which includes a filtration belt to filter water from sludge, a sludge chamber having sludge introduced into the sludge chamber, a pressure applying tube (or membrane), through which air or liquid used to compress the sludge in the sludge chamber is injected, and a gutter to receive the water through the filtration belt, at multiple layers.

Another object of the present invention is to rapidly treat sludge by fixedly coupling a plurality of sludge dehydration sets to a guide and a support, which are configured to fixedly couple or decouple the sludge dehydration sets to be moved up or down, to construct the sludge dehydration sets at the multiple layers, and by moving up or down the sludge chambers provided on a filtration belt using a hydraulic cylinder fixedly installed on an outer frame to couple upper and lower portions of the sludge chambers to each other, filling sludge into the sludge chamber, dehydrating the sludge as pressure is applied by injecting the air or the liquid to the pressure applying tube, and moving the filtration belt to rotate rollers, so that sludge cakes are simultaneously transferred into the sludge cake storage container.

Still another object of the present invention is to provide a sludge dehydration set capable of efficiently performing a dehydration process through a structure provided in the steel mesh net or a matrix having holes to collect water passing through a filtration belt, which filters water from the sludge, under the filtration belt and to firmly support the filtration belt during the dehydration process so that the filtration belt is not bent down, and to discharge the collected water for the dehydration of the sludge, and a sludge dehydration apparatus.

Still another object of the present invention is to reduce the installation space of a sludge dehydration apparatus having multiple layers through a structure of assembling and installing the sludge dehydration apparatus and to easily perform maintenance of the sludge dehydration apparatus through a structure of disassembling the sludge dehydration apparatus in the unit of a layer.

Still another object of the present invention is to reduce installation cost and perform an efficiency control operation by simultaneously injecting air or liquid into chambers using one air or liquid injection pump, or simultaneously injecting the air or the liquid into the chambers in the unit of at least two chambers using one air or liquid injection pump when the air or liquid is injected to each chamber, or by simultaneously introducing sludge using one sludge introduction pump, or introducing the sludge in the unit of at least two chambers using one sludge introduction pump when the sludge is introduced into the chambers.

Still another object of the present invention is to maintain a predetermined interval between layers without the separation of the layers from each other when the layers are moved up and down by forming one block part on upper edge portions of both sides of a frame, forming two block parts under lower edge portions of the both sides of the frame, and coupling guide holes and a guide member, which are provided at the front and rear of the frame to couple upper and lower layers to each other, to each other.

Still another object of the present invention is to install idle rollers at left and right sides of a water collecting part to reduce frictional force between a filtration belt and an upper portion of the water collecting part to reduce damage of the filtration belt and to reduce a load of a motor for driving the roller to save energy when dehydrated sludge is transferred into a sludge storage container after the sludge is dehydrated.

### Technical Solution

In order to accomplish the above objects, there is provided a sludge dehydration apparatus having multiple layers, that rapidly and efficiently treats a great amount of sludge by designing and manufacturing sludge dehydration sets at the multiple layers. Each sludge dehydration set includes a filtration belt to filter water from the sludge, a sludge chamber to receive foods, wastewater, or sewage sludge, a pressure applying tube (or membrane) fixedly installed in the sludge chamber to inject air or liquid used to compress the sludge, and a gutter to collect the water passing through the filtration belt.

According to the present invention, there is provided a sludge dehydration apparatus having multiple layers, which includes a guide and a support to vertically guide or support a sludge dehydration set including a filtration belt, a sludge chamber, a pressure applying tube (membrane) to compress sludge in the sludge chamber, and a gutter, in which the guide and support is configured to move up and down only the sludge chamber and the pressure applying tube (membrane) provided in the sludge chamber using a hydraulic cylinder installed at an upper portion or a lower portion of an outer frame. Rollers to tighten the filtration belt at both edges are fixedly installed integrally with the sludge chamber of a lower sludge dehydration set adjacent to a gutter under the filtration belt.

According to the present invention, there is provided a sludge dehydration apparatus having multiple layers, which rapidly and efficiently treats a great amount of sludge by simultaneously performing a series of operations of introducing sludge into a sludge chamber in sludge dehydration sets constructed at multiple layers, injecting air or liquid into a pressure applying tube, moving up the sludge chamber up after a dehydration process is performed, discharging a sludge cake, and dehydrating the sludge by injecting the air or the liquid into the pressure applying tube (membrane).

According to the present invention, there is provided sludge dehydration sets and a sludge dehydration apparatus having multiple layers, which includes a structure provided in the form of a steel mesh net or a matrix and having holes to support a lower portion of the filtration belt so that the filtration belt is not bent due to the pressure, and to move down the dehydrated water in order to dehydrate the water using the filtration belt by applying pressure to the sludge. In addition, a water collected in a water colleting part through the mesh net or the holes is discharged through a drain port, an air or liquid injection part is installed under the water collecting part, a sludge introduction part is installed under the air or liquid injection part, and a membrane is fixedly installed between the air or liquid injection part and the sludge introduction part, so that the water contained in the sludge is dehydrated and flows downward of the filtration belt by applying pressure to the sludge by using the injected liquid or the air.

According to the present invention, there is provided sludge dehydration sets and a sludge dehydration apparatus having multiple layers, which includes a membrane installed between an air or liquid injection part and a sludge introduction part, formed of a material to represent higher elasticity so that air and sludge do not pass through the membrane, horizontally fixed and installed in the chamber, and vertically moved according to the pressure of the liquid or the air the dehydration of the sludge.

According to the present invention, there is provided sludge dehydration sets and a sludge dehydration apparatus having multiple layers, in which the sludge introduced under the membrane has a lower height, so that the sludge is dehydrated with high dehydration rate as pressure is applied to the membrane, a plurality of layers are formed in the same structure to simultaneously introduce and dehydrate sludge, so that an amount of dehydrated sludge is increased, and the space occupied by the sludge dehydration apparatus can be reduced.

According to the present invention, there is provided a sludge dehydration apparatus having multiple layers, in which one block part is formed on upper edges of both sides of a frame so that the multiple layers are moved up and down to exact positions thereof without being separated from each other, two block parts are formed under lower edges of both sides of the frame, and a guide hole is coupled to a guide member so that the upper and lower chambers maintains a predetermined interval therebetween when the multiple layers are moved up.

### Advantageous Effects

As described above, according to the present invention, a great amount of sludge can be efficiently treated by constructing the sludge dehydration sets, each of which includes the filtration belt to filter water from sludge, the sludge chamber having sludge introduced into the sludge chamber, the pressure applying tube (or membrane), through which air or liquid used to compress the sludge in the sludge chamber is injected, and the gutter to receive the water through the filtration belt, at multiple layers.

According to the present invention, the sludge dehydration sets are coupled to each other in a multi-layer structure, and a guide and a support are provided to move up a portion of the sludge dehydration sets. In addition, after each sludge chamber provided above each filtration belt is moved up using a hydraulic cylinder provided at the upper portion or the lower portion of an outer frame, the roller is rotated to move the filtration belt in one direction, so that the sludge cakes provided on the filtration belts can be simultaneously discharged, thereby rapidly treating the sludge.

The present invention can provide a sludge dehydration set capable of efficiently performing a dehydration process through a structure provided in the steel mesh net or a matrix having holes to collect water passing through a filtration belt, which filters water from the sludge, under the filtration belt and to firmly support the filtration belt during the dehydration process so that the filtration belt is not bent down, and to discharge the collected water for the dehydration of the sludge, and a sludge dehydration apparatus.

According to the present invention, the dehydration process is performed by forming the thin sludge layer to be dehydrated on one layer for the effective dehydration. Multiple layers are formed and mechanically separated from each other for the dehydration process. Accordingly, the whole amount of sludge to be dehydrated is increased, the dehydration time is reduced, and the dehydration rate is increased.

According to the present invention, the installation space of a sludge dehydration apparatus having multiple layers can be reduced through a structure of assembling and installing the sludge dehydration apparatus and maintenance of the sludge dehydration apparatus can be easily performed through a structure of disassembling the sludge dehydration apparatus in the unit of a layer.

According to the present invention, installation cost can be reduced and an efficiency control operation can be performed by simultaneously injecting air or liquid into chambers using one air or liquid injection pump, or simultaneously injecting the air or the liquid into the chambers in the unit of at least two chambers using one air or liquid injection pump when the air or liquid is injected to each chamber, or by simultaneously introducing sludge using one sludge introduction pump, or introducing the sludge in the unit of at least two chambers using one sludge introduction pump when the sludge is introduced into the chambers.

According to the present invention, the membrane, which is fixedly installed above the sludge in order to apply pressure to the sludge for the dehydration of sludge, is moved up or down according to the pressure of the liquid or the air, has high elasticity, and is formed of a material to prevent the liquid, the air, and the sludge from passing through the membrane, so that the sludge can be efficiently dehydrated.

According to the present invention, a predetermined interval between layers can be maintained without the separation of the layers from each other when the layers are moved up and down by forming one block part on upper edge portions of both sides of a frame, forming two block parts under lower edge portions of the both sides of the frame, and coupling guide holes and a guide member, which are provided at the front and rear of the frame to couple upper and lower layers to each other, to each other.

According to the present invention, idle rollers are installed at left and right sides of the water collecting part to reduce frictional force between the filtration belt and the upper portion of the water collecting part to reduce damage of the filtration belt to reduce the damage of the filtration belt, and to reduce a load of a motor for driving the roller to save energy when dehydrated sludge is transferred into a sludge storage container after the sludge is dehydrated.

### DESCRIPTION OF DRAWINGS

FIG. 1 is a view showing the whole structure of a sludge dehydration apparatus including sludge dehydration sets designed and manufactured at multiple layers according to the present invention.

FIG. 2 is a view showing the state that the sludge dehydration apparatus having multiple layers according to the present invention discharges a sludge cake after a dehydration process is performed.

FIG. 3 is a side view showing one sludge dehydration set manufactured according to the present invention (FIG. 3 is shown widthwise for the expansion of fonts).

FIG. 4 is an enlarged view showing one edge of one sludge dehydration set manufactured according to the present invention.

FIG. 5 is a view showing the coupling structure of upper and lower sludge dehydration sets according to the present invention.

FIG. 6 is a plan view showing one sludge dehydration set manufactured according to the present invention.

### BEST MODE

### Mode for Invention

According to the present invention, there is provided a sludge dehydration apparatus having multiple layers, which rapidly and efficiently treats a great amount of sludge by designing and manufacturing sludge dehydration sets at the multiple layers. Each sludge dehydration set includes a filtration belt to filter water from the sludge, a sludge chamber to receive foods, wastewater, or sewage sludge, a pressure applying tube (or membrane) fixedly installed in the sludge chamber to inject air or liquid used to compress the sludge, and a gutter to collect the water passing through the filtration belt.

According to the present invention, there is provided sludge dehydration sets and a sludge dehydration apparatus having multiple layers, which includes a structure provided in the form of a steel mesh net or a matrix and having holes to support a lower portion of the filtration belt so that the filtration belt is not bent due to the pressure, and to move down the dehydrated water in order to dehydrate the water using the filtration belt by applying pressure to the sludge. In addition, a water collected in a water colleting part through the mesh net or the holes is discharged through a drain port, an air or liquid injection part is installed under the water collecting part, a sludge introduction part is installed under the air or liquid injection part, and a membrane is fixedly installed between the air or liquid injection part and the sludge introduction part, so that the water contained in the sludge is dehydrated and flows downward of the filtration belt by applying pressure to the sludge by using the injected liquid or the air.

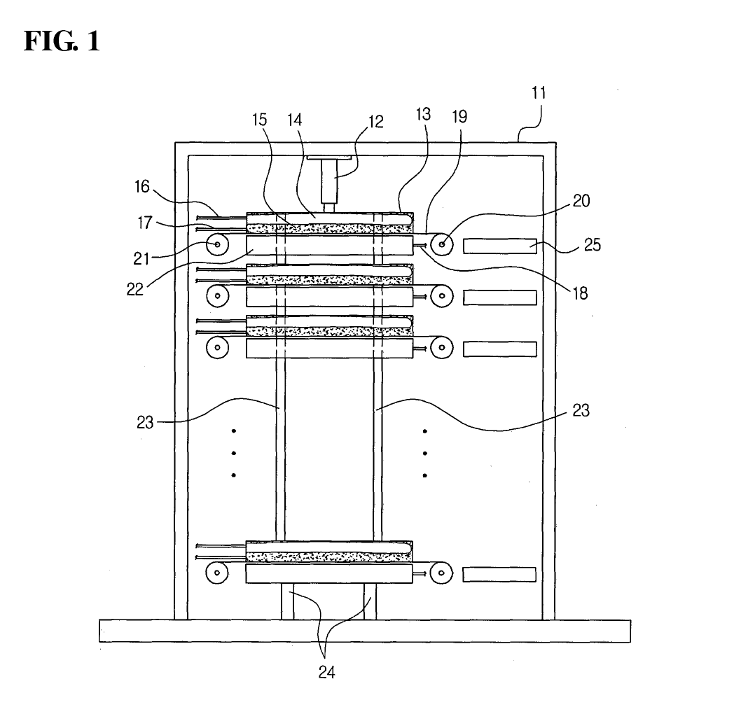

Embodiments of the present invention will be described with reference to accompanying drawings. FIG. 1 is a view showing the whole structure of a sludge dehydration apparatus having sludge dehydration sets designed at multiple layers according to the present invention.

A sludge dehydration set, which is designed according to the present invention to form one layer and to dehydrate sludge (a technical component forming one layer to perform a dehydration process is referred to as “sludge dehydration set”), mainly includes a sludge chamber, into which the sludge is introduced, a filtration belt to filter water from the sludge, a pressure applying tube (or membrane) to increase internal pressure of the sludge chamber, or a gutter.

Conventionally, a sludge dehydration process using the filtration belt is performed by a technical component to remove water and moisture from the sludge by injecting high-pressure gas into the chamber, into which the sludge is introduced. Accordingly, the high-pressure gas used to apply pressure to the sludge passes through the filter, so that moisture removal efficiency may be degraded.

In addition, the technical component is provided in the form of one large container, so that pressure cannot be efficiently applied to the sludge. Accordingly, dehydration time may be prolonged and desirable dehydration efficiency may not be achieved.

Hereinafter, the sludge dehydration set to form one layer in the sludge dehydration apparatus having multiple layers will be described in detail with reference to FIG. 1.

As shown in FIG. 1, a sludge chamber 13 (see FIG. 1), into which sludge is introduced, is positioned at an upper portion of the sludge dehydration set to remove water or moisture from plant waste, wastewater, or sewage sludge

The sludge chamber 13 (see FIG. 1) has a lower portion that is open, and a filtration belt 19 (FIG. 1) closely makes contact with the open lower portion of the sludge chamber to filter water and moisture from the sludge, which is introduced into the sludge chamber, by applying pressure.

A pressure applying tube (membrane) 14 (FIG. 1) is fixedly installed in the sludge chamber 13 (FIG. 1) so that air or liquid is injected into the pressure applying tube to compress the sludge, and a gutter 22 (FIG. 1) is fixedly installed under the filtration belt 19 (FIG. 1) to collect water flowing out of the filtration belt 19 (FIG. 1).

As shown in FIG. 1, rollers 20 and 21 (FIG. 1) are installed at both sides of the filtration belt 19 (FIG. 1) to tighten the filtration belt 19 (FIG. 1) and to easily transfer a dehydrated sludge cake to a sludge cake storage container 25 (FIG. 1) after the dehydration process has been performed.

Only one of the rollers 20 and 21 (FIG. 1) is formed of a rotational motor or both rollers 20 and 21 are formed of rotational motors, so that the filtration belt 19 (FIG. 1) is bi-directionally pulled and tightened, or moved uni-directionally to transfer the dehydrated sludge cake.

The sludge dehydration sets individually and simultaneously perform dehydration processes while unifying the dehydration processes to efficiently dehydrate the sludge, and the dehydrated sludge is stored in the sludge cake storage container 25 (FIG. 1).

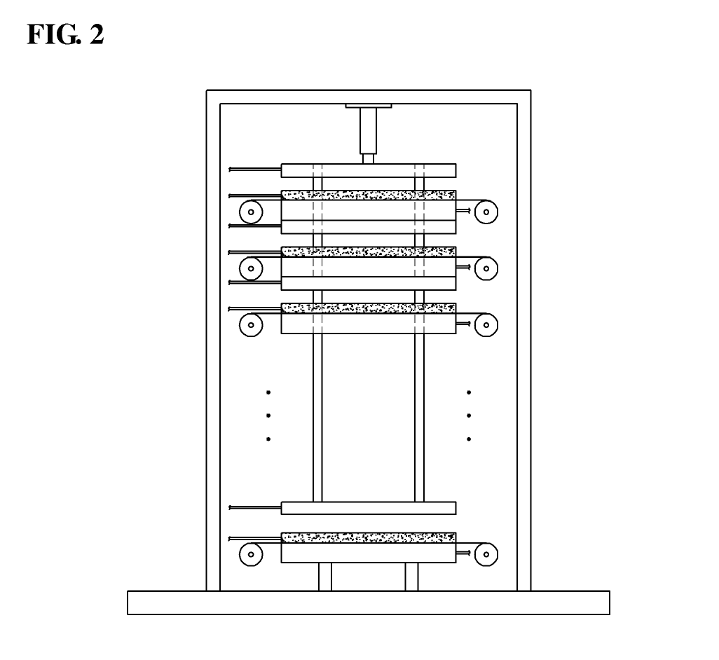

As shown in FIGS. 1 and 2, the sludge dehydration apparatus according to the present invention includes a plurality of sludge dehydration sets, and the sludge dehydration sets perform the same operation at the same time, so that the dehydration process can be rapidly and efficiently performed.

The sludge dehydration sets according to the present invention simultaneously are configured to introduce sludge into the respective sludge chambers from a sludge storage tank in order to perform the same operation at the same time, dehydrate the sludge by injecting air or liquid into the pressure applying tube, and move the dehydrated sludge into the sludge cake storage container 25 (see FIG. 1). Hereinafter, the technical structure will be described in detail.

A sludge introduction port 17 (FIG. 1) is provided at one side of each sludge chamber to introduce the sludge into the sludge chamber.

According to the technical structure in which sludge is simultaneously introduced into the sludge chambers 13 (FIG. 1) from the sludge storage tank (not shown) having the sludge collected from the outside, a branching pipe branches from one pipe coupled to the sludge storage tank, and is coupled to each sludge introduction port provided in the each sludge chamber 13 (FIG. 1) through a pipe, and one sludge introduction pump is installed at one side of one pipe, so that the sludge is introduced into the sludge chamber.

The sludge introduction pump may be installed at one side of each pipe branching from one pipe so that the sludge is simultaneously introduced into the sludge chambers, or may be installed in the unit of a group so that the sludge is introduced into the sludge chambers 19 (FIG. 1).

The pipe may be formed of a metallic material, or a synthetic resin material having flexibility, or the metallic material and the synthetic resin materials may be used according to sections of the pipe. In other words, the pipe may be formed of various materials sufficient to endure pressure required for the dehydration process and to represent superior durability.

Hereinafter, the pressure applying tube (membrane) positioned inside the sludge chamber 13 (FIG. 1) to remove water or moisture from the sludge will be described in detail.

An air or liquid injection port 16 (FIG. 1) is installed at one side of the pressure applying tube (membrane) 14 (FIG. 1) positioned inside the sludge chamber 13 (FIG. 1) and used to inject air or liquid to dehydrate the sludge by increasing the internal pressure of the sludge chamber as the air or the liquid is injected into the pressure applying tube (membrane) 14 (FIG. 1).

An air or liquid injection pump, which injects the air or the liquid, is installed at one side of an air or liquid injection pipe communicating with the air or liquid injection port 16 (FIG. 1).

Similarly to the structure of introducing the sludge into the sludge chamber, the air or liquid injection pump is configured to inject air or liquid into the pressure applying tube (membrane) 14 (FIG. 1) under preset pressure using one air or liquid injection pump through the coupling with the air or liquid injection port installed in each pressure applying tube (membrane) 14 (FIG. 1).

Alternatively, the air or liquid injection pump may be installed at one side of each air or liquid injection port to inject air or liquid at predetermined pressure, thereby increasing the internal pressure of the sludge chamber through the pressure applying tube (membrane) 14 (FIG. 1).

The pressure applying tube (membrane) 14 (FIG. 1) installed inside the sludge chamber 13 (FIG. 1) may be formed of a rubber material or a synthetic resin material allowing the pressure applying tube (membrane) to expand when pressure is increased by injecting air or liquid, or contract when the pressure of the air or the liquid is lowered, and to endure high pressure, and to represent superior durability.

The pressure applying tube (membrane) 14 (FIG. 1) is designed and formed to have a shape matched with the shape of the inside of the sludge chamber 19 (FIG. 1) and fixedly installed at an inner upper portion of the sludge chamber 13 (FIG. 1) to efficiently apply pressure to sludge provided at a lower portion of the sludge chamber.

Regarding another technical structure, several pressure applying tubes (membranes) 14 (FIG. 1) are grouped, and the air or liquid injection pump is installed in the unit of a group to inject air or liquid into the pressure applying tube (membrane), thereby increasing the internal pressure of each sludge chamber.

Hereinafter, description will be made regarding the structure of transferring a sludge cake into the sludge cake storage container 25 (FIG. 1) after allowing the sludge chamber 13 (FIG. 1) having the open lower portion to closely make contact with the filtration belt 19 (FIG. 1), introducing the sludge into the sludge chamber 13 (FIG. 1), and then applying pressure to the sludge by injecting the air or the liquid through the pressure applying tube (membrane) 14 (FIG. 1) to dehydrate the sludge.

As shown in FIG. 1, in order to transfer the sludge cake into the sludge cake storage container 25 (FIG. 1), after moving the sludge chamber individually having the pressure applying tube (membrane) 14 (FIG. 1) up using a hydraulic cylinder 12 (FIG. 1) fixedly installed at an upper portion of the outer frame 11 (FIG. 1), the sludge cake positioned on the filtration belt is transferred to the sludge cake storage container 25 (FIG. 1) by rotating the rollers installed at both edges of the filtration belt.

The hydraulic cylinder 12 (FIG. 1) fixedly installed at the upper portion of the outer frame 11 (FIG. 1) may be lifted at a preset height so that sludge cakes contained in the sludge chambers 13 (FIG. 1), respectively, can be simultaneously transferred into the sludge cake storage container after the dehydration process has been performed. The position of the hydraulic cylinder 12 (FIG. 1) may be changed according to occasions.

The rollers 20 and 21 (FIG. 1) are installed at both edges of the filtration belt to tighten the filtration belt in the dehydration process for the sludge cake provided on the filtration belt, and to move the filtration belt after the dehydration process has been finished.

Both rollers 20 and 21 are formed of rotational motors or only one of the rollers 20 and 21 (FIG. 1) is formed of a rotational motor, so that the filtration belt 19 (FIG. 1) is bi-directionally or uni-directionally wound and tightened. If necessary, the sludge cake may be transferred into the sludge cake storage container 25 (FIG. 1) by rotating both rotational motors or one rotation motor.

According to another embodiment, the sludge cake may be transferred into the sludge cake storage container 25 (FIG. 1) by fixing the slurry chamber 13 (FIG. 1) and the pressure applying tube (membrane) 14 (FIG. 1), and simultaneously moving down each filtration belt 19 (FIG. 1) and each gutter 22 (FIG. 1) using the hydraulic cylinder 12 (FIG. 1).

The technical structure of transferring the sludge cake into the sludge cake storage container according to the present invention may have various modifications within the scope of the present invention.

FIG. 2 shows the state that the sludge cake is transferred into the sludge cake storage container 25 (FIG. 1) after moving the sludge chambers 13 (FIG. 1) and the pressure applying tubes (membranes) 14 (FIG. 1) using the hydraulic cylinder 25 (FIG. 1) in the sludge dehydration apparatus having the multiple layers described above.

In order to design and manufacture the sludge dehydration sets in multiple layers according to the present invention, a plurality of guides and supports are fixedly installed on the frame of the apparatus.

As shown in FIGS. 1 and 2, four guides and supports are provided, and a hydraulic cylinder may cooperate with the four guides and supports so that the guides and supports move up and down. Alternatively, the guides and the supports may be fixedly installed.

The sludge chamber 13 (FIG. 1) having the pressure applying tube (membrane) 14 (FIG. 1) therein is moved up along four guides and supports 23 (FIG. 1) using the hydraulic cylinder 12 (FIG. 1) to transfer the sludge cake into the sludge cake storage container after the sludge has been dehydrated.

The filtration belt 19 (FIG. 1), the gutter 22 (FIG. 1), and the rollers 20 and 21 (FIG. 1) are fixedly installed on the outer frame 23 (FIG. 1) and/or four guides and supports 23 (FIG. 1).

One guide and one support or at least two guides and at least two supports are variously modified.

In order to move the sludge chamber 12 (FIG. 1) using the hydraulic cylinder 12 (FIG. 1) to a preset height, the sludge chamber 12 (FIG. 1) must be spaced apart from the gutter 22 (FIG. 1) by a predetermined interval during the dehydration process for the movement of the sludge cake.

According to another embodiment, the sludge chamber 12 (FIG. 1) having the pressure applying tube (or membrane) therein is fixedly installed on the guide and the support 23 (FIG. 1) and/or the outer frame 23 (FIG. 1), and the rollers, the filtration belt, and the gutter can be simultaneously moved down using the hydraulic cylinder.

As shown in FIG. 1, according to the sludge dehydration apparatus according to the present invention, a lower support is installed on a floor of the outer frame, and the above-described guides and supports 23 (FIG. 1) are fixedly installed on the lower support.

According to still another embodiment, a plurality of guides and supports are fixedly installed in the outer frame while extending from the floor of the outer frame to the upper portion of the outer frame, and the sludge dehydration sets may be fixedly installed.

According to still another embodiment, the sludge dehydration apparatus may be configured to form the gutter and the lower chamber integrally with each other, and to move up a filter and rollers.

According to still another embodiment, when sludge dehydration sets configured at multiple layers are divided into upper sludge dehydration sets and lower sludge dehydration sets, a latch is provided to uniformly maintain an interval between the upper sludge dehydration sets and the lower sludge dehydration sets.

The latch is a conventional coupling unit to couple and/or decouple a cover and a body or portions of the body to and/or from each other in a bag, or a vessel, such as a portable pot, having multiple layers.

The interval refers to an interval sufficient to discharge sludge, which is provided on the filtration belt, from the filtration belt when the sludge hydration sets coupled to each other by the latch are decoupled from each other.

In other words, the interval has a height slightly greater than that of the dehydrated sludge.

The present invention may have various modifications based on the technical structure. Various structures, in which the sludge dehydration sets are installed at multiple layers, so that a great amount of sludge can be simultaneously and rapidly treated with the higher dehydration rate and efficiency, are within the scope of the present invention.

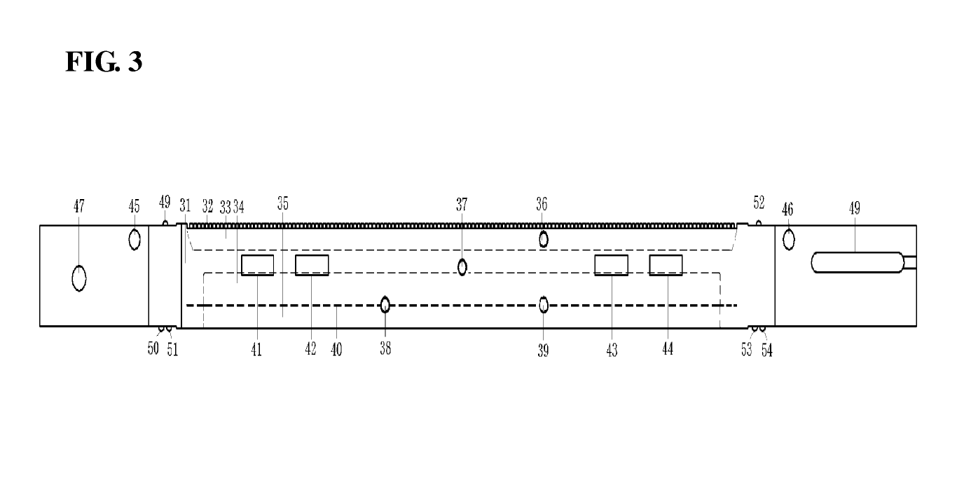

Hereinafter, the embodiment of the present invention will be described in detail with reference to accompanying drawings. FIG. 3 is a side view showing one sludge dehydration set manufactured according to the present invention.

According to the sludge dehydration apparatus of the present invention, sludge dehydration sets can be easily assembled and manufactured at multiple layers. The sludge introduced into the chamber is formed at a lower height, the sludge dehydration efficiency can be improved, and the dehydration time can be reduced. The individual maintenance for each sludge dehydration set is possible, so that maintenance cost can be significantly saved.

In addition, when one sludge dehydration set is failed, the dehydration of the failed sludge and the injection of the liquid or the air to dehydrate the sludge are stopped with respect to only the failed chamber, and remaining chambers may be operated normally. In addition, the failed sludge dehydration set may be rapidly and easily repaired by replacing only a failed part with new one.

The structure of the present invention will be described with reference to FIG. 3.

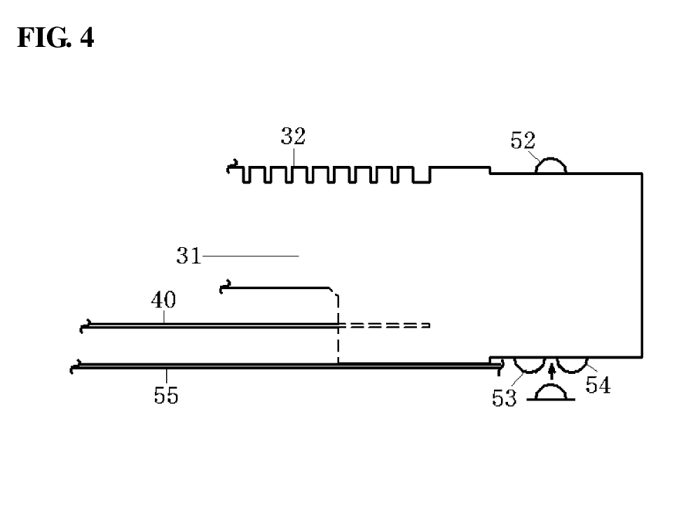

A structure 32 of FIG. 3 having the form of a steel mesh net or having a large number of holes arranged in the form of a matrix is fixedly installed at the upper portion of the sludge dehydration chamber to support the filtration belt 55 (FIG. 4) so that water can be efficiently removed through the filtration belt without the sagging of the filtration belt downward due to pressure, and to move the water dehydrated by the pressure to a water collecting part provided at a lower portion of the sludge, when the water is removed from the sludge through the filtration belt 55 (FIG. 4) by applying pressure to the sludge.

The structure 32 of FIG. 3 having the form of a steel mesh net or having a large number of holes arranged in the form of a matrix is formed of an anti-rust metallic material or a synthetic resin material to represent superior durability. The structure 32 may be manufactured in a square shape or a rectangular shape or in an injection-molding scheme. In other words, the structure 32 may be formed of various materials sufficient to endure pressure applied in the dehydration process.

A water collecting part 33 (FIG. 3) is provided at a lower portion of the structure 32 of FIG. 3 having the form of a steel mesh net or having a large number of holes arranged in the form of a matrix, and a water drain port 36 (FIG. 3) is provided at a lower portion of an edge of a front surface or a rear surface of the water collecting part 33 (FIG. 3).

A partition is formed to completely separate the water collecting part 33 (FIG. 3) provided in the chamber from an air or liquid injection part 34 (FIG. 3), and the chamber may be formed of a metallic material or a synthetic resin material to ensure pressure applied to the chamber when the liquid and the air are injected into the air or liquid injection port 37 (FIG. 3) for the dehydration of the water and to represent superior durability.

The air or liquid injection port 37 (FIG. 3) is fixedly installed at the upper portion of the front surface or the rear surface of the air or liquid injection part 34 (FIG. 3) of the chamber as a closed space is formed under the water collecting part 33 (FIG. 3), and the membrane 40 (FIG. 3) formed of a material to represent high elasticity is attached to the lower portion of the air or liquid injection part 34 (FIG. 3) for sealing.

The membrane 40 (FIG. 3) is fixedly installed in the chamber to move up or down when the internal pressure of the chamber is changed as the liquid or the air is injected into the air or liquid injection port 37 (FIG. 3). The membrane 40 (FIG. 3) is inserted at a predetermined depth into the chamber in all directions for the coupling as shown in FIG. 4, so that the membrane 40 is sealed (the use of an adhesive agent is possible).

The membrane 40 (FIG. 3) is formed of a material to represent higher elasticity and superior durability, and must prevent liquid, air, and sludge from passing through the membrane. For example, the membrane 40 (FIG. 3) may be provided in the form of a plane including a rubber material. In addition, the membrane 40 may be formed using a synthetic resin material to represent higher elasticity and superior durability. The membrane 40 (FIG. 3) is designed in the form of a furrowed bellows so that the membrane 40 can be more easily adapted to the change of pressure.

A space between the water collecting part 33 (FIG. 3) and the air or liquid injection part 34 (FIG. 3) inside the chamber is firmly divided by the partition, so that the chamber has resistance to the pressure of the liquid or the air applied to the lower portion of the chamber, and the pressure of the liquid or the air can be applied to the membrane.

The sludge introduction ports 38 and 39 (FIG. 3) are formed at one side of the chamber 31 (FIG. 3) between the membrane 40 (FIG. 3) and the filtration belt 55 (FIG. 4), that is, at one side (front surface or rear surface of the chamber) under the membrane fixedly installed in the chamber. The sludge introduction ports 38 and 39 (FIG. 3), into which the sludge is introduction at one side of the chamber 3 (FIG. 31) between the membrane 40 (FIG. 3) and the filtration belt 55 (FIG. 4), are formed at one side of a lower portion of the membrane fixedly installed in the chamber (corresponding to the front surface or the rear surface of the chamber). After the sludge is introduced into the sludge introduction part 35 (FIG. 3) by a predetermined amount through the sludge introduction ports 38 and 39 (FIG. 3), which are fixedly installed, a valve installed at one side of the sludge introduction ports 38 and 39 (FIG. 3) is closed. The air or liquid is injected into the air or liquid injection port 37 (FIG. 3) to apply preset pressure to the sludge, so that the water contained in the sludge flows out under the filtration belt 35 (FIG. 4).

A pressure sensor is installed at one inner side of the air or liquid injection part 34 (FIG. 3) to measure the pressure of the air or liquid injection part, so that the pressure applied by the liquid or air injected through a liquid or air injection pump is measured to maintain a preset pressure.

The air or liquid injection pump is installed at an outer portion of the air or liquid injection part 34 (FIG. 3) installed in each chamber to inject liquid or air. The air or liquid air injection pump communicates with the air or liquid injection port 37 (FIG. 3) through a pipe or a hose to inject liquid or air.

Although it is preferred that the chambers and the air or liquid injection pump are coupled to each other in parallel through the pipe or the hose so that the air or the liquid may be injected into the air or liquid injection part 34 (FIG. 3), the air or liquid injection pump may be installed in each chamber, or installed in the unit of two chambers.

An openable valve is fixedly installed on each sludge introduction pipe to cut off or allow the introduction of the sludge. The valve may include an automatic valve or a manual valve.

Although it is preferred that the sludge introduction part 35 (FIG. 3) installed in each chamber introduces sludge into the chamber by the sludge introduction pump, and the sludge introduction pump is coupled with the sludge introduction ports 38 and 39 (FIG. 3) in parallel to each other through a pipe or a horse, so that the sludge can be simultaneously introduced into the chambers, the sludge introduction pump may be individually installed in each chamber or installed in the unit of two chambers.

In order to discharge the dehydrated sludge from the front and the rear of the chamber 31 (FIG. 3), an upper portion of the uppermost chamber is firmly coupled to a hydraulic cylinder or a pneumatic cylinder through a coupling unit (not shown), so that the chamber may be lifted to the preset height from the filtration belt using the hydraulic cylinder and the pneumatic cylinder. After the chamber has been lifted, the filtration belt is moved rightward using the rollers installed at the left and right lower portions of the chamber, so that the dehydrated sludge cake is transferred to the sludge cake storage vessel.

When the sludge is dehydrated, the upper chamber is closely pressed to the lower chamber using the hydraulic cylinder or the pneumatic cylinder, so that the lower portion of the chamber closely makes contact with the filtration belt. Accordingly, the injected liquid or air does not leak to the outside, but is used to apply pressure to be used in the dehydration process.

The filtration belt 55 (FIG. 4) is mechanically installed seperably from each chamber, the upper and lower chambers adjacent to each other closely makes contact with each other when the sludge is dehydrated, and the chamber positioned above the filtration belt may be lifted to the preset height in order to discharge the dehydrated cake after the sludge has been dehydrated.

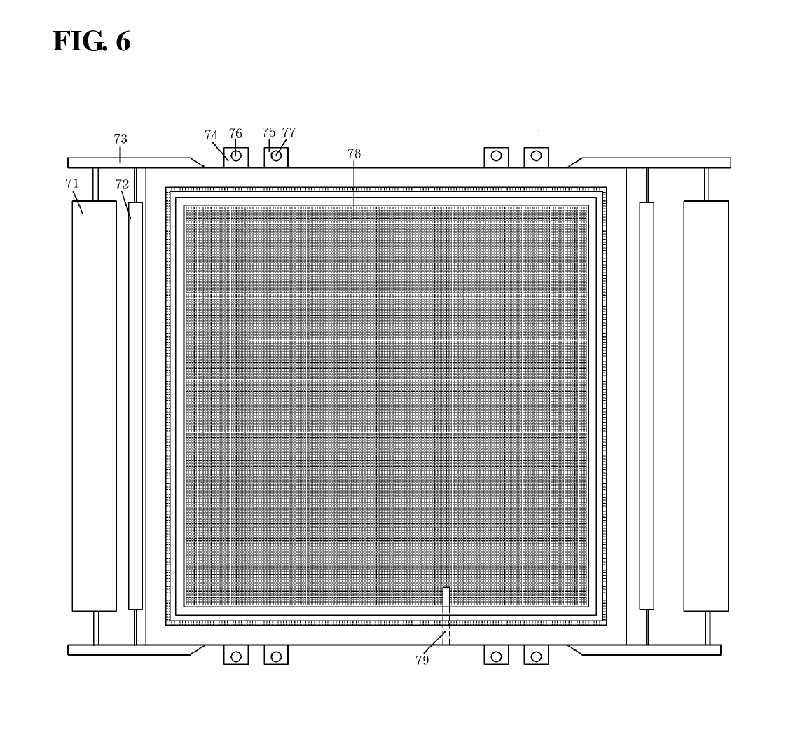

The rollers 71 (FIG. 6), which are installed at the left and right sides of the filtration belt installed seperably installed from the chamber, tighten the filtration belt by a motor installed in one roller or motors installed in both rollers, and transfer the dehydrated sludge positioned on the filtration belt to the sludge cake storage container (not shown) as the rollers 71 are rotated.

One block part is formed on upper edges of both sides of the frame 73 (FIG. 6) so that the chambers can be moved up and down to exact positions thereof without being separated from each other, and two block parts are formed under lower edges of both sides of the frame 73 (FIG. 6) so that the upper block part is interposed between two lower block parts, when simultaneously moving up the chambers constructed at the plural layers in order to transfer the dehydrated cake to the dehydrated cake storage container after the dehydration process has been performed, or moving the chambers onto the filtration belt after the dehydrated cake has been transferred. Two upper block parts and one lower block part may be formed by changing the positions of the upper and lower block parts.

Preferably, the block parts are designed and manufactured so that a space is not formed between the chambers when the sludge is dehydrated, and installed on left and right frames having no filtration belts.

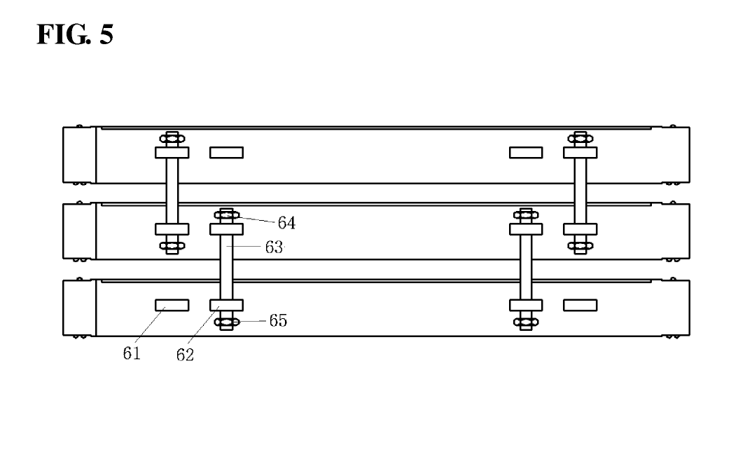

Guide hole members 74 and 75 (FIG. 6) having guide holes 76 and 77 (FIG. 6) protrude from the front and the rear of the chamber, respectively, so that upper and lower chambers are not separated from each other. Guide members 53 (FIG. 5) are coupled to upper and lower guide holes 76 and 77 (FIG. 6) to hold chambers vertically adjacent to each other. The guide members 53 (FIG. 5) is configured to prevent the guide members 53 (FIG. 5) from being separated from the guide holes 76 and 77 (FIG. 6) when locking members 64 and 65 (FIG. 5) are coupled to the upper and lower chambers after the guide members are inserted into the guide holes 76 and 77 (FIG. 6).

Since the guide hole members 74 and 75 (FIG. 6) having the guide holes 76 and 77 (FIG. 6) and the guide members 53 (FIG. 5) uniformly maintain the interval between chambers when the uppermost chamber is lifted by the hydraulic cylinder or the pneumatic cylinder in order to transfer the dehydrated cake after the sludge has been dehydrated, the guide hole members 74 and 75 (FIG. 6) having the guide holes 76 and 77 (FIG. 6) and the guide members 53 may have various modifications. According to another example to uniformly maintain the interval between chambers, after an elongated hole is vertically lengthwise formed in a plate-shape guide member and vertically coupled to the guide hole member having the guide hole, a coupling member is fixedly installed to prevent each guide hole from being separated from the plate-shape guide member to maintain the set interval.

The guide hole members 41 to 44 shown in FIG. 3 are installed at the front and the rear of the each chamber, and two guide hole members are installed at each of the left and right sides of the chamber because the guide members can be prevented from colliding with each other. In detail, when two inner guide hole members are used to be coupled with upper chambers, two outer guide hole members are coupled to the lower chambers to uniformly maintain the interval between the chambers when the chambers are moved up in order to discharge the dehydrated sludge cake, and to prevent the guide hole members from colliding with each other when the chambers are moved down. If the lower chambers are lifted together with the upper chambers when the upper chambers are lifted on the chambers, so that the interval between chambers can be uniformly maintained to discharge the sludge cake, various structures are possible.

According to the present invention, idle rollers 72 (FIG. 6) are installed at left and right sides of the water collecting part of the chamber under the filtration belt to reduce the frictional force between the filtration belt and an upper portion of the water collecting part, to reduce the load of the motor driving the roller, and to reduce the damage of the filtration belt when the dehydrated sludge cake is transferred into the sludge cake storage container after the sludge has been dehydrated, so that the sludge can be smoothly transferred into the sludge cake storage container.

A spring 48 (FIG. 3) for adjusting the tension of the filtration belt may be fixedly installed on one side of the frame provided at one of right and left edges of the chamber to support the roller so that the tension of the filtration belt can be supported.

When the sludge dehydration sets according to the present invention are formed at multiple layers, the uppermost chamber needs not have a structure 78 (FIG. 6) provided in the form of a steel mesh net or in the form of a matrix and having holes and the water collecting part. However, when the sludge dehydration set according to the present invention is employed as it is, an upper water collecting part must be used.

When the sludge dehydration sets according to the present invention are formed at multiple layers, the lowermost chamber needs not have the air or liquid injection part and the sludge introduction part. However, when the sludge dehydration set according to the present invention is employed as it is, a lower air or liquid injection part and a lower sludge introduction part must be used.

After forming the sludge dehydration sets according to the present invention at multiple layers, in order to move up the uppermost chamber for the transferring of a dehydrated sludge cake or to move down a chamber after the sludge cake is transferred into the sludge storage container, the guide hole and the guide member are firmly coupled to the front and the rear of the uppermost chamber, so that the uppermost chamber can be moved up and down using the hydraulic cylinder and the pneumatic cylinder.

The guide members having a predetermined length are coupled to the guide holes provided at the upper and lower chambers so that the space between the chambers can be maintained at a predetermined interval when the chambers are vertically moved.

In detail, preferably, the height of the chamber is in the range of 5 cm to 40 cm. Preferably, the length and the width of each chamber are in the range of 0.5 m to 1.5 m. The numeric range may have various values by taking into consideration the length and the width of the chamber, the height ratio of the chamber, an amount of disposed sludge, and the disposal efficiency of the sludge.

The technical components generally known to those skilled are not described in the specification for the present invention, and mutually different numeric numbers are assigned to the same components in FIGS. 3, 4, and 6.

The steel mesh, the water collecting part to collect water, the membrane, the air or liquid injection port used to inject air or liquid, the sludge introduction part, and the filtration belt constitute one sludge dehydration set provided at one layer in the sludge dehydration apparatus according to the present invention, and are subject matters of the present invention.

The above-described sludge dehydration set may have various modifications, and the modifications are the scope of the present invention.

### INDUSTRIAL APPLICABILITY

The present invention provides a sludge dehydration set, in which a sludge filtration belt is positioned at a lower portion of a sludge chamber having an open lower portion, sludge is introduced into the sludge chamber, a pressure applying tube is installed above the introduced sludge, water is filtered and discharged through the filtration belt by applying pressure to the sludge so that a dehydration process is performed, a structure is installed under the filtration belt and provided in the form of a steel mesh net or a matrix having many holes to support the filtration belt so that the filtration belt is not bent or sagged while moving down the dehydrated water, and the pressure is applied to the sludge by injecting liquid or air to a membrane positioned above the sludge after the sludge has been introduced into the sludge introduction part, so that the water contained in the sludge is dehydrated and moved down from the filtration belt, and a sludge dehydration apparatus manufactured by assembling a plurality of sludge hydration sets to each other at multiple layers, thereby rapidly and efficiently treating a great amount of sludge to represent significantly high industrial applicability.

1. A sludge dehydration apparatus having multiple layers, the sludge dehydration apparatus comprising a sludge dehydration set comprising:
a sludge filtration belt tightened by rollers provided at both sides of the sludge filtration belt to filter water or moisture from sludge;
a sludge chamber having the sludge introduced into the sludge chamber, closely making contact with an upper portion of the sludge filtration belt, and having an open lower portion to remove the water and the moisture from the sludge;
a pressure applying tube or a membrane positioned at an inner upper portion of the sludge chamber to apply pressure to the sludge using air or liquid that is injected; and
a gutter to collect water produced when the pressure is applied to the sludge through the pressure applying tube,
wherein sludge dehydration sets are constructed at the multiple layers to dehydrate a great amount of sludge.

2. The sludge dehydration apparatus of claim 1, further comprising a guide and a support to fixedly install a plurality of sludge chambers, a plurality of pressuring applying tubes, a plurality of rollers, a plurality of filtration belts, and a plurality of gutters to construct the sludge dehydration sets at the multiple layers.

3. The sludge dehydration apparatus of claim 1, further comprising a hydraulic cylinder provided at an upper portion or a lower portion of an external frame to move up each sludge chamber provided therein with the pressure applying tube such that the sludge chamber closely makes contact with the filtration belt to remove the water and the moisture from the sludge by filtering the water and the moisture from the sludge in a dehydration process and transfers a sludge cake produced through the dehydration process into a sludge cake storage container.

4. The sludge dehydration apparatus of claim 1, wherein each sludge chamber provided in the sludge dehydration apparatus having the multi-layer structure has a sludge introduction port,
a branch pipe branching from one pipe coupled with a sludge storage tank is coupled with the sludge introduction port such that the sludge is introduced into the sludge chamber, and
one of a structure of installing one sludge introduction pump at one side of the pipe coupled to the sludge storage tank, a structure of installing at least two sludge introduction pumps in a unit of a group, and a structure of installing the sludge introduction pump at one side of the branch pipe is selected.

5. The sludge dehydration apparatus of claim 1, wherein the gutter is integrally assembled with a lower sludge chamber.

6. The sludge dehydration apparatus of claim 1, further comparing a latch to maintain a preset interval between upper and lower sludge dehydration sets when the sludge dehydration sets constructed at the multiple layers are coupled to each other and then decoupled from each other.

7. The sludge dehydration apparatus of claim 4, further comprising: an air or liquid injection port installed at one side of the pressure applying tube or the membrane provided in each sludge chamber;
an air or liquid injection pump provided to inject air or liquid into the pressure applying tube such that pressure is applied to an inner part of the sludge chamber; and
a branch pipe branching from one pipe coupled to one air or liquid injection pump, which is coupled to the air or liquid injection port to inject the air or the liquid, or at least two air or liquid injection pumps are provided.

8. The sludge dehydration apparatus of claim 7, wherein the pressure applying tube or the membrane is expanded to apply the pressure to the sludge when the air or the liquid is injected to increase the pressure, and contracted when pressure by the air or the liquid is lowered, and includes a rubber material or a synthetic resin material to endure higher pressure and to represent high durability.

9. The sludge dehydration apparatus of claim 7, wherein the pressure applying tube is formed corresponding to an inner shape of the sludge chamber and fixedly installed at an upper portion of the sludge chamber.

10. A sludge dehydration set comprising:
a structure provided in a form of a steel mesh net, or a matrix, having a plurality of holes, and positioned under a filtration belt to support the filtration belt such that the filtration belt is not bent or sagged while moving dehydrated water down;
a water collecting part installed under the structure provided in the form of the steel mesh, the mesh net, and the matrix and having the holes to collect the dehydrated water;
an air or liquid injection part installed under the water collecting part to receive liquid or air injected into the air or liquid injection part such that pressure is applied to sludge;
a membrane provided at a lower end of the air or liquid injection part, having elasticity, and having a sealing structure to prevent the liquid, the air, and the sludge from passing through the membrane such that pressure of the liquid or the air injected into the air or liquid injection part is applied to the sludge;
a sludge introduction part installed under the membrane to receive the sludge to be dehydrated; and
a filtration belt installed under the sludge introduction part and tightened by rollers installed at lower edges of both sides of a chamber to dehydrate the sludge introduced into the sludge introduction part using the pressure applied by the air or liquid injection part.

11. The sludge dehydration set of claim 10, further comprising: a sludge introduction port installed at an upper portion of the sludge introduction part provided on a front surface or a rear surface of the chamber and closed by a valve installed at one side of the sludge introduction port after the sludge is introduced into the sludge introduction port by a preset amount; and
an air or liquid injection port installed at an upper portion of the air or liquid injection part provided on the front surface or the rear surface of the chamber to receive the liquid or the air by an air or liquid injection pump to apply the pressure to the sludge.

12. The sludge dehydration set of claim 10, wherein the membrane has elasticity to be expanded or contracted according to injection of the liquid or the air, and includes a material to prevent the liquid, the air, and the sludge from passing through the membrane.

13. The sludge dehydration set of claim 10, further comprising members having guide holes, which are provided on the front surface and the rear surface of the chamber to prevent upper and lower chambers from being separated from each other,
wherein upper and lower guide holes are coupled to each other by a guide member having a predetermined length to hold the chamber,
wherein two members having the guide holes are provided at each of left and right sides of the chamber, two members having the guide holes provided at an inner part of the chamber are coupled to the upper chamber, and two members having the guide holes provided at an outer part of the chamber are coupled to the lower chamber to prevent guide members from colliding with each other in chamber coupling, and
wherein locking members are coupled to upper and lower portions of the guide member to prevent the guide member from deviating from the guide hole.

14. The sludge dehydration set of claim 13, further comprising idle pulleys installed at left and right sides of the water collecting part of the chamber under the filtration belt to reduce frictional force between the filtration belt and an upper portion of the water collecting part, to reduce a load of a motor for driving the roller, and to reduce damage of the filtration belt when the dehydrated sludge is transferred into a sludge storage container after the sludge is dehydrated.

15. The sludge dehydration set of claim 10, wherein one block part is formed on upper edges of both sides of a frame such that adjacent chambers are moved up and down to exact positions thereof without being separated from each other, and two block parts are formed under lower edges of both sides of the frame such that the one block part is interposed between the two block parts, when the chambers constructed at multiple layers are simultaneously moved up to transfer a dehydrated sludge cake to the sludge storage container, or the chambers are moved down onto the filtration belt after the dehydrated sludge cake is transferred.

16. The sludge dehydration set of claim 10, further comprising a partition formed between the water collecting part of the sludge dehydration set and the air or liquid injection part such that the pressure applied by the air or liquid injection part is endured, wherein the partition is configured to transfer the pressure to the membrane when the liquid or the air is injected into the air or liquid injection part.

17. The sludge dehydration set of claim 10, further comprising a pressure sensor installed at one inner side of the air or liquid injection part to measure pressure applied by liquid or air injected by an air or liquid injection pump such that a set pressure is maintained.

18. A sludge dehydration apparatus having multiple layers, the sludge dehydration apparatus comprising a sludge dehydration set comprising:
a structure provided in a form of a steel mesh net, or a matrix, having a plurality of holes, and positioned under a filtration belt to support the filtration belt such that the filtration belt is not bent or sagged while moving dehydrated water down;
a water collecting part installed under the structure provided in the form of the steel mesh, the mesh net, and the matrix and having the holes to collect the dehydrated water;
an air or liquid injection part installed under the water collecting part to receive liquid or air injected into the air or liquid injection part such that pressure is applied to sludge;
a membrane provided at a lower end of the air or liquid injection part, having elasticity, and having a sealing structure to prevent the liquid, the air, and the sludge from passing through the membrane such that pressure of the liquid or the air injected into the air or liquid injection part is applied to the sludge;
a sludge introduction part installed under the membrane to receive the sludge to be dehydrated; and
a filtration belt installed under the sludge introduction part and tightened by rollers installed at lower edges of both sides of a chamber to dehydrate the sludge introduced into the sludge introduction part using the pressure applied by the air or liquid injection part,
wherein sludge dehydration sets are constructed at the multiple layers.

19. The sludge dehydration apparatus of claim 18, wherein the sludge dehydration apparatus moves up a plurality of chambers to discharge the dehydrated sludge by coupling an uppermost chamber to a hydraulic cylinder or a pneumatic cylinder, and allows the chambers to closely make contact with the filtration belt using the hydraulic cylinder or the pneumatic cylinder above the chambers when the sludge is dehydrated.

20. The sludge dehydration apparatus of claim 18, wherein the sludge dehydration apparatus couples sludge introduction ports of the chambers to a sludge introduction pipe in parallel to simultaneously introduce a preset amount of sludge into sludge introduction parts.

21. The sludge dehydration apparatus of claim 18, wherein the sludge dehydration apparatus couples air or liquid injection ports of the chambers to an air or liquid injection pipe or hose in parallel to simultaneously inject liquid or air having preset pressure to air or liquid injection parts.

22. The sludge dehydration apparatus of claim 18, further comprising members having guide holes, which are provided on a front surface and a rear surface of the chamber to prevent upper and lower chambers from being separated from each other,
wherein upper and lower guide holes are coupled to each other by a guide member having a predetermined length to hold the chamber,
wherein two members having the guide holes are provided at each of left and right sides of the chamber, two members having the guide holes provided at an inner part of the chamber are coupled to the upper chamber, and two members having the guide holes provided at an outer part of the chamber are coupled to the lower chamber to prevent guide members from colliding with each other in chamber coupling, and
wherein locking members are coupled to upper and lower portions of the guide member to prevent the guide member from deviating from the guide hole.
